(19) United States
(12) Patent Application Publication
(10) Pub. No.: US 2013/0048237 A1
(43) Pub. Date: Feb. 28, 2013

(54) Vehicle or Rack Mountable Shade Apparatus

(71) Applicant: Jeff L. Mathews, Clovis, CA (US)

(72) Inventor: Jeff L. Mathews, Clovis, CA (US)

(21) Appl. No.: 13/598,597

(22) Filed: Aug. 29, 2012

Related U.S. Application Data
(60) Provisional application No. 61/529,388, filed on Aug. 31, 2011.

(51) Int. Cl. E06B 9/24; E04F 10/00

(52) U.S. Cl. 160/368.1; 160/377

(57) ABSTRACT

A shade apparatus configured to mount to a rack on a vehicle or to one the sides of a vehicle so as to provide a shaded area substantially adjacent the vehicle without using support poles or lines. The shade apparatus comprises a housing that attaches to the rack or vehicle, a shade screen that creates the shaded area, a retracting mechanism disposed inside the housing and attached to the shade screen to allow it to be extended or retracted, a pair of side arms that extend outward to support the screen and close inward when the vehicle is to be moved, a locking mechanism interconnecting the shade screen and arms for locking the shade screen in its extended position and a securing means for securing the arms to the housing with the shade screen in its retracted position. The shade apparatus is quick and easy to setup and take down.

### CROSS-REFERENCE TO RELATED APPLICATIONS

This patent application claims the priority to U.S. Provisional Patent Application No. 61/529,388 filed Aug. 31, 2011.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The present invention relates generally to awnings, canopies, sun shades and like shade apparatuses that are configured and utilized to block the sun so as to provide shade. More specifically, the present invention relates to such shade apparatuses that are configured to be attached to a vehicle and to a rack or the like associated with a vehicle. Even more particularly, the present invention relates to such vehicle or rack mountable shade apparatuses that are configured to be easily and quickly setup to provide shad and taken down when not needed and when the vehicle can be moved.

B. Background

The use of temporary awnings, tent structures and other shade apparatuses to block the sun and provide shade to one or more persons under the shade apparatus is well known in the prior art. The typical awning is fixedly attached to the side or roof of a building so as to extend outwardly therefrom. These awnings generally require either one or more poles, ropes, wires, lines or other such devices, typically a plurality of such devices, to position the awning so it will provide the desired shade. As with awnings, most tent structures and other shade apparatuses require at least the use of one or more poles or other support members to provide the necessary canopy that produces the shaded area or a variety of ropes, wires or other lines to support the canopy. Typically, most tent and tent-like structures require both support members and lines. As well known, these support members and lines require additional room for the structure and very often get in the way of persons around the structure. Not too surprisingly, people often walk into the support members or trip over the lines, often either damaging the support members or lines and/or injuring themselves. As such, it is generally beneficial to have a shade apparatus that does not require the use of support members and/or lines to form the canopy that produces the desired shaded area.

Presently available shade structures use a wide variety of materials for the portion of the structure that actually produces the shade. As well known, some of these materials are solid so as to allow substantially no light to pass through the shade portion and others have varying degrees of holes or other openings through which some light can pass. In addition to allowing light to pass through the openings, these shade portions also allow some amount of ambient air to pass through the openings, which may assist with cooling of the area below the shade portion. Although a wide variety of materials can be utilized for the shade portion of these apparatuses, the most commonly utilized materials for awnings, tents and tent-like shade structures include various canvas and canvas like materials that are at least somewhat flexible to allow the shade portion to be folded, rolled or otherwise more easily put away. In addition to ease of handling and storage, the use of a flexible shade portion is also beneficial for those shade structures that in which the shade portion is retractable.

Retractable shade structures generally have a housing that encloses a retracting mechanism, which is configured to at least retract the shade portion, and the shade portion when it is fully retracted. While many, if not most, of the retracting mechanisms are configured to only retract the shade portion, requiring the user to manually pull the shade portion out of the housing to produce the canopy that creates the shaded area, some retracting mechanisms also extend the shade portion. Some retracting mechanisms are motorized. Naturally, the retracting mechanisms that extend the shade portion and which are motorized are somewhat more complicated to manufacture and, as a result, generally more expensive to purchase. The configuration, operation and uses for retracting mechanisms are generally well known in the art. Many are the subject of issued patents, whether for the retracting mechanism itself, other aspects of the shade apparatus or for the entire shade apparatus.

One potential use for shade apparatuses is for persons who work outdoors. Most such apparatuses fall within those described above and, as such, have problems with regard to tripping over the support members or lines that are used to produce the canopy. In addition, most of the available awnings and tent or tent-like structures are at least somewhat difficult and/or time consuming to setup and dismantle. Due to the problems or potential problems, very often most job sites do use shade structures. However, as well known, at many job sites the workers are exposed or at least substantially exposed to the rays of the sun while they work. This exposure to the sun can overheat the workers and cause them to be less efficient, more prone to make mistakes and/or become ill. As a result of the possible illness or other injury issues related to overheating, some states, municipalities and other government entities require the employer to provide a shaded rest area for workers when the ambient temperature exceeds a certain level. For instance, Cal/OSHA's Title 8 Regulation, Article 3395(d), which is directed at preventing heat related illnesses, has explicit requirements for providing shade that is applicable to all outdoor places of employment. Pursuant to this law, shade is required to be present when the temperature exceeds 85 degrees Fahrenheit. The employer must provide enough shade to accommodate 25% of the employees on any one shift at any time, employees must be allowed and encouraged to take a cool-down rest in the shade for a period of no less than five minutes when needed to prevent overheating and access to shade must be permitted at all times.

Although many outdoor job sites do have shade available, either from the work itself, such as inside or adjacent a building, or under a nearby object, such as a tree or other building, many job sites do not have ready access to shade unless the employer provides the shade. For instance, workers who install rebar or otherwise build the foundation stage of a building often do not have shade readily available to them. Either the employer must provide a shade apparatus to create the shaded area or the workers must sit in a vehicle, usually with the air conditioning running, or drive to where there is shade. Unless the employer has a shade apparatus, the other ways of cooling down can be very time consuming and, as a result, lead to a loss of efficiency. As stated above, most shade apparatuses are somewhat difficult to setup and disassemble and require the use of support members and/or lines to form the canopy that actually produces the shaded area where the workers can rest.

The prior art discloses a number of shade apparatuses that attach to the vehicle or which require the vehicle as part of the structure that holds the canopy portion of the shade apparatus in position. As with shade apparatuses in general, these shade apparatuses usually require support members and/or wires that connect to the ground to provide the shade canopy. In addition, most of the prior art vehicle-related shade apparatuses are somewhat difficult and time consuming to setup and disassemble. Because these shade apparatuses use part of the vehicle for support, they must be disassembled every time the vehicle is removed and then re-setup when the shaded area is required. As such the prior art vehicle-related shade structures are generally not commonly utilized to provide shade, particularly in the work environment.

What is needed, therefore, is an improved shade apparatus that is quick and easy to setup when a shaded area is desired or necessary and quick and easy to disassemble and move when the shaded area is no longer necessary. Preferably, the improved shade apparatus will be configured to be attached to a rack associated with a vehicle or to the vehicle itself so it can be readily available at an outdoor area job site. To avoid safety issues with regard to poles and other support members and outwardly extending wires, the preferred shade apparatus will not require the use of any support members or wires to support the apparatus, including the canopy which produces the shaded area. Preferably, the improved shade apparatus will be relatively simple to manufacture so the cost thereof will be reasonable and relatively quick and simple to operate so that it can be setup and disassembled as often as it is needed or as necessary to move the vehicle associated therewith.

### SUMMARY OF THE INVENTION

The vehicle or rack mountable shade apparatus of the present invention solves the problems and provides the benefits identified above. That is to say, the present invention discloses a shade apparatus which is configured to be mounted to a vehicle, such as vans and the like, or to a rack that is associated with a vehicle, such as a truck rack mounted on the bed of a pick-up truck or the like. The shade apparatus of the present invention is quick and easy to setup when a shaded area is desired or necessary/required and quick and easy to disassemble and move when the shaded area is no longer necessary or the vehicle to which it is attached, directly or indirectly, needs to be moved. The shade apparatus of the present invention does not require the use of any support members or wires to support the shade portion of the apparatus, thereby avoiding the potential safety issues normally associated with shade apparatuses that do require the use of support members and/or wires. The present shade apparatus is relatively simple to manufacture, such that the cost thereof is reasonable, and relatively quick and simple to operate, so that it can be setup and disassembled as often as it is needed or as necessary to move the vehicle to which the shade apparatus is attached.

In one general aspect of the present invention, the shade apparatus comprises a housing enclosing a chamber therein, a mounting mechanism to mount the housing to a rack or the side of a vehicle, a shade screen having a body that is made out materials selected so as to provide a shaded area when acted upon by sunlight, a retracting mechanism disposed in the housing chamber and operatively attached to a first end of the shade screen so as to allow the shade screen to move between a retracted position and an extended position, a pair of side arms that are each pivotally attached to the housing, and a locking mechanism which is associated with and interconnects the shade screen and the side arms for locking the shade screen in its extended position. When the shade screen is in its retracted position, the shade screen is disposed substantially in the housing with a second end of the body of the shade screen generally against or at the housing. When the shade screen is in its extended position, the second end of the shade screen body extends outwardly from the housing to produce the shaded area. Each of the side arms are configured to pivot between a closed condition with the side arms substantially adjacent the housing and an open position with the side arms extending outwardly from the housing generally toward the second end of the shade screen when the shade screen is in its extended position. A securing mechanism associated with the housing and/or the side arms is utilized for securing the side arms in their closed position. In one embodiment, the shade apparatus is utilized with a rack on a vehicle and the mounting mechanism is configured to attach the housing to a frame member of the rack so as to provide the shaded area substantially adjacent the vehicle. In another embodiment, the shade apparatus is the mounting mechanism is configured to attach the housing to a side of a vehicle so as to provide the shaded area substantially adjacent the vehicle. The mounting mechanism can comprise one or more brackets that are attached to the housing, with the brackets structured and arranged to be mounted to the rack or to the vehicle. The securing mechanism can be one or more strap members attached to the housing and a connecting mechanism associated with at least one of the strap members. The locking mechanism can comprises an elongated bar member that is laterally disposed at the second of the shade screen and one or more engagement openings disposed in each of the side arms. The bar member can have ends that extend beyond the body of the shade screen, with the ends of the bar member being cooperatively sized and configured with the engagement openings in the side arms to be received in the engagement openings and lock the shade screen in the extended position.

Accordingly, the primary objective of the present invention is to provide a shade apparatus that provides the advantages discussed above and which overcomes the disadvantages and limitations associated with presently available shade apparatuses.

It is an important object of the present invention to provide a shade apparatus that is configured to be mounted to a vehicle, such as the side of a van and the like, or to a rack associated with a vehicle, such as a rack on the bed of a pickup truck or the like, with the shade apparatus structured and arranged so as to provide a shaded area substantially next to the vehicle.

It is also an important object of the present invention to provide a shade apparatus that is configured to be mounted on a vehicle or a rack that is associated with a vehicle and structured and arranged to provide a shaded area substantially next to the vehicle that can be utilized to shade one or more persons from the heat of the sun.

It is also an important object of the present invention to provide a shade apparatus that is configured to be mounted on a vehicle or a rack that is associated with a vehicle and which comprises a retracting mechanism that is structured and arranged to allow a shade screen to be moved between a closed position for movement of the vehicle and an extended position for providing a shaded area substantially adjacent to the vehicle.

It is also an important object of the present invention to provide a shade apparatus comprising a housing that is mountable to a side of a vehicle or to a rack on a vehicle, a shade screen made out of a material selected to provide a shaded area, a retracting mechanism disposed inside a chamber of the housing and connected to the shade screen so as to allow the shade screen to extend outwardly from the vehicle and retract into the chamber of the housing, a pair of side arms pivotally attached to the housing so as to move between a collapsed condition and an open position and a locking mechanism associated with the side arms and shade screen that locks the shade screen in its extended position.

Another important object of the present invention is to provide a shade apparatus structured and arranged with side arms that are pivoted open to support a shade screen in an extended position and which are pivoted closed and secured to allow movement of vehicle to which the shade apparatus is directly or indirectly attached.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a shade apparatus configured according to the present invention shown mounted to a rack on a pickup truck with the shade screen in its retracted position and the side arms in their closed condition;

FIG. 2 is a side perspective view of the shade apparatus of FIG. 1 with the side arms shown in their open condition;

FIG. 3 is a side perspective view of the shade apparatus of FIG. 3 with the shade screen shown partially extended;

FIG. 4 is a side perspective view of the shade apparatus of FIG. 4 with the shade screen shown in its extended position so as to provide the shaded area;

FIG. 5 is a side perspective view of the shade apparatus of FIG. 1;

FIG. 6 is a side perspective view of the shade apparatus of FIG. 5 with the side arms shown in their open condition;

FIG. 7 is a side perspective view of the shade apparatus of FIG. 6 with the shade screen shown in its extended position;

FIG. 8 is a side perspective view of the shade screen of the shade apparatus of FIG. 5;

FIG. 9 is a side perspective view of the housing of the shade apparatus of FIG. 5 showing the chamber inside the housing, the retracting mechanism disposed inside the chamber and the opening in the housing through which the shade screen extends; and

FIG. 10 is a side perspective view of a shade apparatus configured according to the present invention shown mounted to a sidewall of vehicle with the shade screen in its retracted position and the side arms in their closed condition.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and the description set forth herein are primarily directed to a retractable shade apparatus that is mountable to a truck rack of a pickup truck, persons skilled in the art will readily understand that this is merely for purposes of simplifying the present disclosure and that the present invention is not so limited. The shade apparatus can also be attached to one of the sides, including the back, of a van or other vehicle.

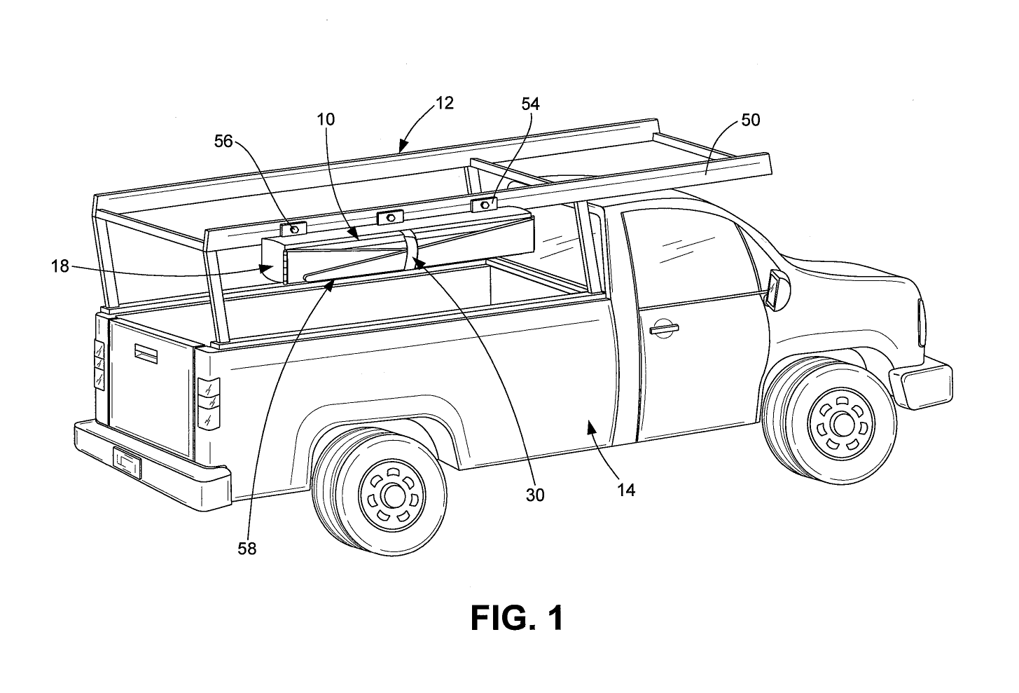

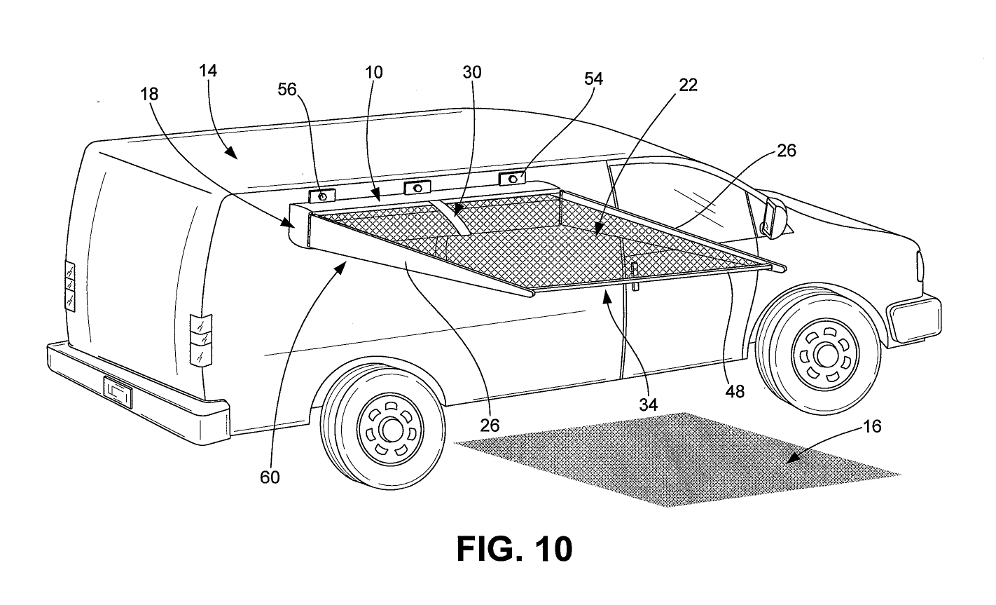

A shade apparatus that is made from the components and which is configured pursuant to one or more embodiments of the present invention is referred to as 10 in FIGS. 1 through 7 and 10. As set forth in more detail below, shade apparatus 10 of the present invention is configured to be mounted directly to a rack 12 on a vehicle 14, such as the truck rack and pickup truck combination shown in FIGS. 1 through 4, to provide a shaded area 16 substantially adjacent the vehicle 14 that can be utilized by workers and other persons as necessary to get out of the heat of the sun or, as may be applicable, out of the rain, snow, hail or other weather condition. As shown in FIG. 10, shade apparatus 10 can also be attached directly to vehicle 14, such as to a side wall, including the back side wall, of a van or the like. As will be readily appreciated by those skilled in the art, the shade apparatus 10 of the present invention can be utilized with a side variety of different types of racks 12, including those identified as utility racks, ladder racks and the like, and vehicles 14 having such racks 12 or to the vehicle 14 itself. Depending on the size of the applicable components of shade apparatus 10, shaded area 16 can be sufficiently large for a plurality of persons to sit under so as to get away from the sun's rays or other weather conditions. Likewise, if desired more than one shade apparatus 10 can be utilized with a single vehicle 14, either on opposite sides of vehicle 14 or, depending on the respective lengths of the shade apparatus 10 and rack 12 and/or vehicle 14, along the same side of the vehicle 14. In a preferred configuration, the shade apparatus 10 is mounted sufficiently high on the rack 12 or vehicle 14 so persons can, as desired, stand in the shaded area 16. As will be set forth in more detail below, the primary benefits of the shade apparatus 10 of the present invention include easy and quick setup and dismantling, relatively easy mounting to the rack 12 or vehicle 14, providing the shaded area 16 without the use of any poles and/or wires, ropes or other lines and ability to securely close the shade apparatus 10 when the user thereof desires or needs to move the vehicle 14.

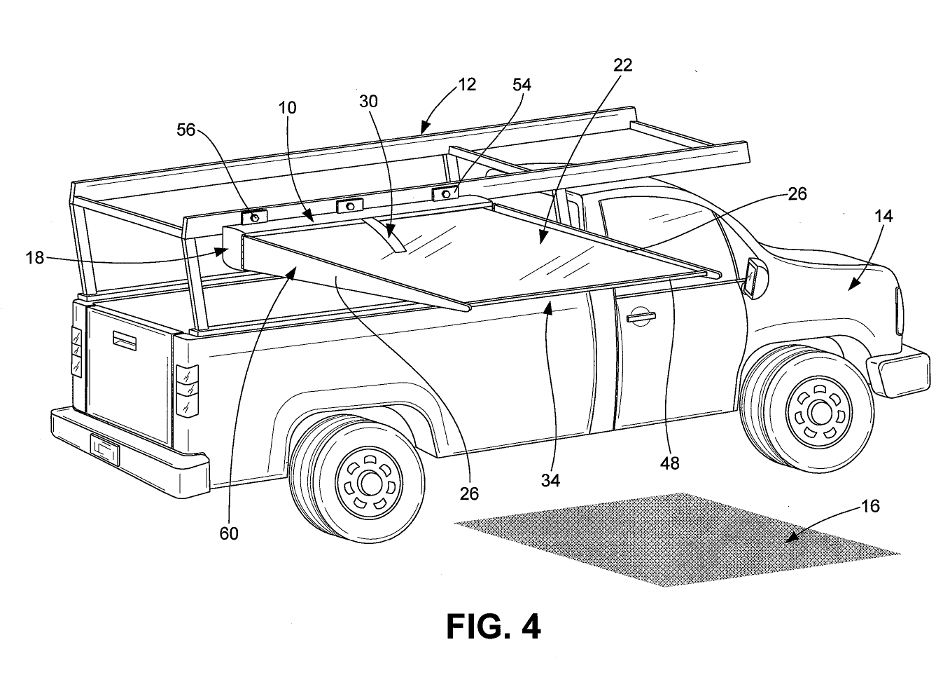

The shade apparatus 10 of the present invention primarily comprises a housing 18, a mounting mechanism 20 for mounting the housing 18 to the rack 12 or vehicle 14, a shade screen 22 that creates the shaded area 16, a retracting mechanism 24 disposed in housing 18 that is configured to allow the user to extend or retract the shade screen 22, one or more (preferably two) side arms 26 that support the extended shade screen 22, a locking mechanism 28 that locks the shade screen 22 to the side arm(s) 26, a securing mechanism 30 to securely hold the side arms 26 substantially adjacent to the housing 18 when the shade screen 22 is not extended. The configuration, use and relationship of the various components of shade apparatus 10 are set forth in more detail below. As stated above, the components of shade apparatus 10 allow the shade apparatus 10 to be mounted to a rack 12 or a vehicle 14 so that it can be moved with vehicle 14, with shade screen 22 in its retracted position 32 (as best shown in FIGS. 1, 2 and 9), and, when the vehicle 14 is parked, with the shade screen 22 in its extended position 34 (as best shown in FIGS. 4 and 7) to provide the shaded area 16 is desired or necessary.

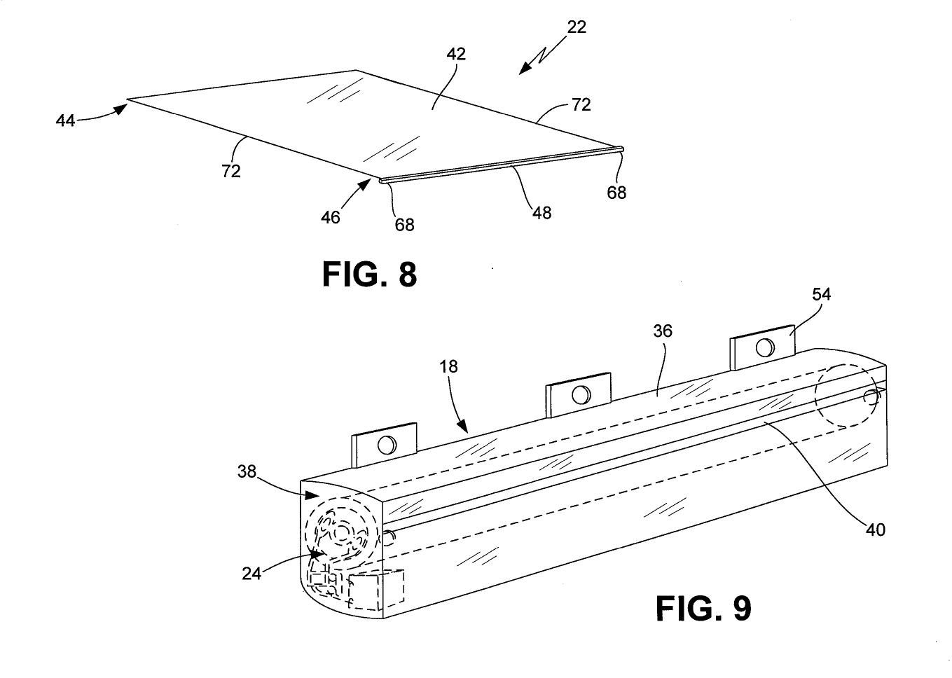

As best shown in FIG. 9, the housing 18 comprises one or more side walls 36 that enclose a chamber 38 in which the retracting mechanism 24 is disposed. Housing 18 can have a generally circular, oval, square, rectangular or other shaped cross-section and can be made out of a wide variety of different materials that provides the necessary support for the retracting mechanism and are suitable for use in outdoor environments. Typically, the retracting mechanism 24 is attached to the inner surface of one or more of the side walls 36 to prevent any undesirable movement of the retracting mechanism 24 inside chamber 38 and to provide the necessary leverage for the extending and retracting movement of the shade screen 22. A slit or other opening 40 is provided in one of the side walls 36 or between two adjacent side walls 36 to allow the shade screen 22 to extend out of the housing 18. The body 42 of the shade screen 22 has a first end 44 that is attached to the retracting mechanism 24 and a second end 46 that extends outwardly from the housing 18 when shade screen 22 is in its extended position 34. In the retracted position 32, most of the body 42 of the shade screen 22 is wrapped around a tubular component of the retracting mechanism 24. As well known in the art, at least a portion of the second end 46 of the shade screen 22 remains outside the housing 18 when shade screen 22 is in its retracted position 32 to allow the user to grasp the shade screen 22 to pull it to its extended position 34. In one embodiment of the present invention, best shown in FIGS. 7 and 8, the shade screen 22 has an elongated bar member 48 at or near the second end 46 of the body 42 of shade screen 22 that remains outside of housing 18 when the shade screen 22 is in its retracted position 32. If desired, the side wall 36 of housing 18 near the opening 40 can be shaped, such as being slightly concaved, to receive the bar member 48 so the side arms 26 can lay closer against the housing 18 when shade apparatus 10 is not in use.

The mounting mechanism 20 allows the housing 18 of the shade apparatus 10 to be securely mounted to the rack 12 or to the vehicle 14. In the embodiment shown in FIGS. 1 through 4, the mounting mechanism 20 mounts housing 18 to one of the frame members 50 of the rack 12. In the embodiment of FIG. 10, the mounting mechanism 20 secures housing 18 of shade apparatus 10 to one of the vehicle sidewalls 52 of vehicle 14. As will be readily appreciated by those skilled in the art, mounting mechanism 20 can be configured to mount the housing 18 to any of the frame members 50 of the rack 12 or sidewalls 52 of the vehicle 14, whether along the side of the vehicle 14 (as shown in the figures) or along the back or front of the vehicle 14. In the embodiment shown in the figures, mounting mechanism 20 comprises one or more brackets 54 (three are shown) that are attached to the outer surface of at least one of the side walls 36 of the housing 18. The brackets 54 can be attached to housing 18 by welding or by using connectors such as bolts, screws, rivets and the like. The brackets 54 will typically be attached to the frame member 50 of rack 12 or to the sidewall 52 of vehicle 14 using one or more screws, bolts or other removable connectors 56. If desired, however, the brackets 54 may be welded or riveted to the frame member 50 or sidewall 52. As will be readily appreciated by those skilled in the art, a wide variety of connectors or techniques may be used to attach the brackets 54 to the housing 18 and to the frame member 50 or sidewall 52. In addition to brackets 54, a variety of other devices may be utilized to connect, removably or fixedly, the housing 18 to the frame member 50 or sidewall 52. Alternatively, the housing 18 may be welded or otherwise directly attached to the frame member 50 or sidewall 52, as appropriate.

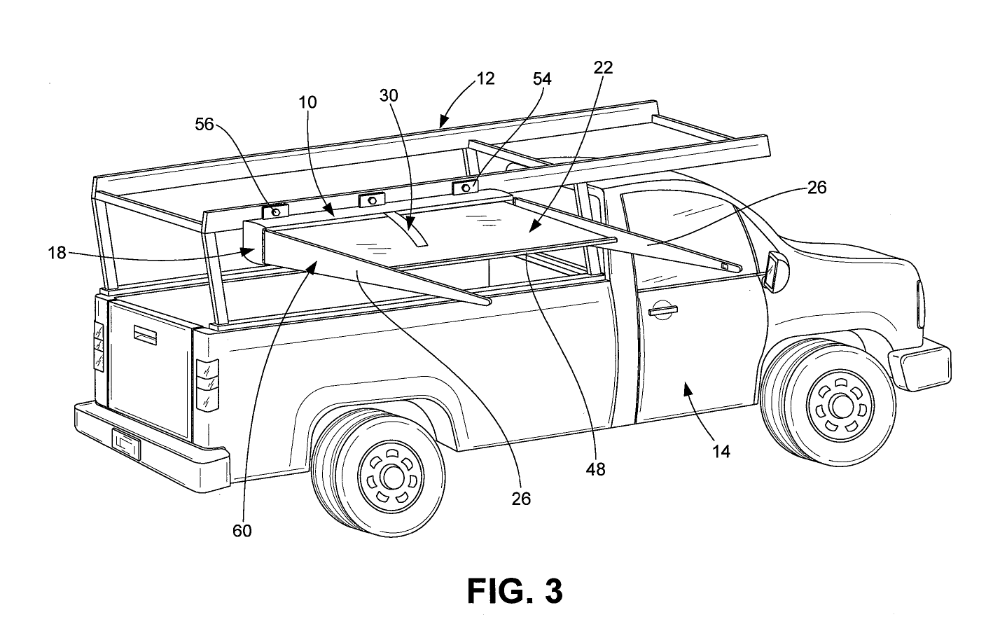

As set forth above, the shade screen 22 has a body 42 that is made out of one or more materials that are selected to provide the desired shaded area 16. In one embodiment, shown in FIGS. 3-4 and 7-8, shade screen 22 is made out of a solid sheet of such material. In an alternative embodiment, shown in FIG. 10, shade screen is configured with a plurality of small holes that allow air to pass through body 42. The materials for the body 42 of shade screen 22 are well known in the art and commonly used for awnings and the like. As with housing 18, the material for the shade screen 22 needs to be selected so as to be at least generally resistant to damage by exposure to the sun and other weather elements, including wind, rain, snow, hail, dust and the like as shade apparatus 10 is intended to be mounted on rack 12 or vehicle 14 and left thereon during the duration of its life (unless moved to another rack 12 or vehicle 14). The length of shade screen 22 can be as long as what can be appropriately handled by the retracting mechanism 24 and be at least substantially received inside of housing 18. Likewise, the width of shade screen 22 will be less, though not necessarily much less, than the width of the housing 18. During manufacture, the dimensions of the housing 18, shade screen 22 and retracting mechanism 24 and the handling capacity of retracting mechanism 24 will be cooperatively sized.

As stated above, the first end 44 of the body 42 of shade screen 22 will typically be attached to the retracting mechanism 24 and an elongated bar member 48 will be laterally disposed at or near the second end 46 of the body 42 of shade screen 22. In this embodiment, the bar member 48 should be stiff enough to laterally support the width of the body 42 of shade screen 22, which must be selected so as to be sufficiently flexible to wrap around components of the retracting mechanism 24 to be disposed inside the chamber 38 of housing 18 when shade screen 22 is in its retracted position 32. Being stiff will allow the user to grasp the bar member 48 to pull the shade screen 22 out of the housing 18. If desired, a handle or other grasping device, not shown, can be attached to bar member 48 to further assist the user with pulling the shade screen 22 out of the housing 18. The bar member 48 can have a round, oval, square, rectangle or a variety of other cross-sections. Alternatively, instead of a separate bar member 48, a thickened portion of the body 42 of shade screen 22 can be positioned at the second end 46 thereof to allow the user to grasp the shade screen 22 to pull it out of the housing 18 and place shade screen 22 in its extended position 34. As set forth in more detail below, the bar member 48, thickened portion or other device at the second end 46 of the body 42 of shade screen 22 is also utilized as part of the locking mechanism 28 that locks the shade screen in its extended position 34 so it can provide the desired shaded area 16.

The retracting mechanism 24 is structured and arranged to retract the shade screen 22 inside the housing 18 and to allow the user to pull the shade screen 22 out of the housing 18. In a typical configuration, the first end 44 of the body 42 of shade screen 22 is fixedly attached to retracting mechanism 24 and the body 42 is sufficiently flexible to wrap around a tubular portion of retracting mechanism 24. Typically, retracting mechanism 24 has a spring-loaded device that tends to draw the body 42 of the shade screen 22 into the housing 18, requiring only a slight pulling force to pull the shade screen 22 out of the housing when the shaded area 16 is required. As will be readily appreciated by those skilled in the art, a variety of different types of retracting mechanisms 24 can be utilized with the shade apparatus 10 of the present invention. Such mechanisms are well known in the art and are commonly utilized with retractable awnings, sun screens, projector screens, window shades and the like. Although many of these other uses have the retracting mechanism configured so it can lock in one or more extended lengths, such a configuration is not likely to be beneficial for the retracting mechanism 24 of the present invention. Instead, as set forth in more detail below, the present invention beneficially utilizes the retracting force of the retracting mechanism 24 to secure the shade screen 22 in its extended position 34. In some circumstances, however, it may be beneficial to utilize a retracting mechanism 24 that does have a locking component thereto to assist in locking the shade screen 22 in its extended position 34.

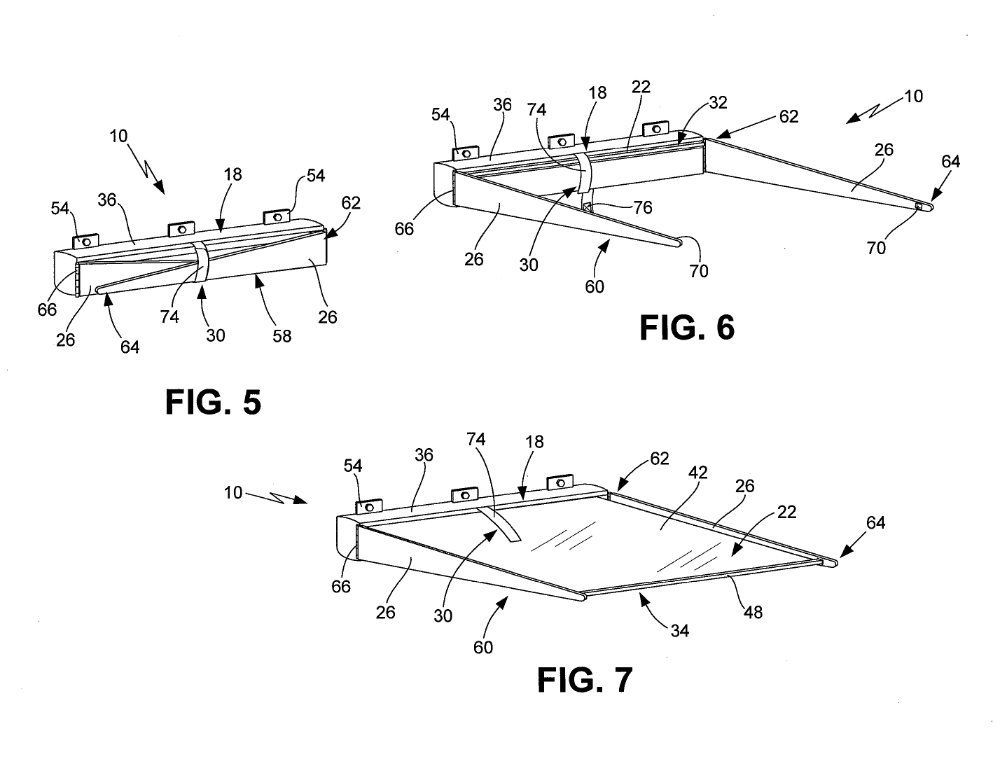

Pivotally attached to the housing 18 is one or more side arms 26 that are structured and arranged to engage the shade screen 22 and hold the shade screen 22 in its extended position 34 to produce the shaded area 16 when acted upon by sunlight, as best shown in FIGS. 4 and 10. In the preferred embodiment, a pair of side arms 26 are utilized with shade apparatus 10. The side arms 26 are pivotally attached to the housing 18 so the side arms 26 will pivot between a closed condition 58 with the side arms 26 positioned substantially adjacent the housing 18, as shown in FIGS. 1 and 5, and an open condition 60 with the side arms 26 extending substantially outwardly from the housing 18, as shown in FIGS. 1-4, 6-7 and 10. Each of the side arms 26 have a proximal end 62 that is pivotally attached to the housing 18 and positioned thereon such that when the side arms 26 are in their open condition 60, the distal end 64 of the side arms 26 extend outward generally towards the second end of shade screen 22 when the shade screen 22 is in its extended position 34, as best shown in FIGS. 4 and 10. In a preferred embodiment, a hinge 66 interconnects the proximal end 62 of each of the side arms 26 and a side wall 36 of the housing 18, as best shown in FIGS. 5 through 7. The hinges 66, and thus the proximal end 62 of each side arm 26, are in spaced apart relation to each other such that the side arms 26 extend outwardly from the housing 18 substantially at or near the ends of the housing 18 so as to be disposed along each side of the shade screen 22, as best shown in FIGS. 6 and 7. In a preferred embodiment, the hinges 66 are of the type that allow the user to easily unfold the side arms 26 to their open condition 60, where the side arms 26 will remain while the user pulls on the bar member 48, or a pull handle attached thereto, to extend the shade screen 22 to its extended position 34. The side arms 26 should be sufficiently stiff to support their own weight when they are in the open condition 60 and hold the shade screen 22 in the extended position 34 so it will produce the shaded area 16.

As set forth above, the shade apparatus 10 of the present invention comprises a locking mechanism 28 that is structured and arranged to lock the shade screen 22 in its extended position 34 so it will remain in the extended position 34 until the user decides to move the shade screen 22 to its retracted position 32 when shaded area 16 is not needed. In a preferred embodiment of the shade apparatus 10, the locking mechanism 28 interconnects the second end 46 of shade screen 22 and the distal ends 64 of each of the side arms 26. In the embodiment shown in the figures, the locking mechanism 28 comprises the outwardly extending ends 68 of the elongated bar member 48 and cooperatively configured engagement openings 70 at or near the distal end 64 of each side arm 26, as best shown in FIGS. 6 through 8. As best shown in FIG. 8, the ends 68 of the bar member 48 extend past the sides 72 of the body 42 of the shade screen 22. These outwardly extending ends 68 are sized and configured to be received in the engagement openings 70, best shown in FIG. 6, positioned at or towards the distal end 64 of each side arm 26 to securely hold the shade screen 22 in its extended position 34, as best shown in FIGS. 4, 7 and 10. With the side arms 26 swung open at hinges 66 and the ends 68 of the bar member 48 disposed in the engagement openings 70, the side arms 26 will be kept in spaced apart relation by the elongated bar member 48. In this position, the retracting force provide by the retracting mechanism 24 will provide sufficient tension on the body 42 of shade screen 22 to maintain shade screen 22 generally flat across its length and width so as to provide the desired shaded area 16 next to the side of the vehicle 14, as shown in FIGS. 4 and 10.

Although the various figures show this one embodiment of locking mechanism 28, persons skilled in the art will readily appreciate that a wide variety of different configurations of locking mechanism 28 can be utilized with the shade apparatus 10 of the present invention to interconnect the second end 46 of the shade screen 22 and the distal end 64 of the side arms 26 to hold shade screen 22 in its extended position 34. For instance, the distal end 64 of each side arm 26 can be provided with a slot in which the outwardly extending ends 68 of the bar member 48 can be received to hold the shade screen 22 in its extended position 34. Alternatively, the second end 46 of shade screen 22 and the distal end 64 of side arms 26 can be provided with cooperatively configured devices, such as hooks and eye bolts or the like, that allow the devices at the second end 46 of shade screen 22 to engage the devices at the distal ends 64 of side arms 26 in a manner that maintains the shade screen 22 in its extended position 34 to provide the desired/needed shaded area 16. In another alternative configuration, cooperatively configured brackets or like devices can be utilize at the second end 46 of shade screen 22 and the distal ends 64 of the side arms 26.

The shade apparatus 10 of the present invention also comprises a securing mechanism 30 that securely holds side arms 26 in their closed condition 58, as best shown in FIGS. 1 and 5, over the second end 46 and bar member of the shade screen 22, which is in its retracted position 32 due to the retracting force provided by retracting mechanism 24, so the vehicle 16 can be driven about without concern that the side arms 26 will inadvertently and undesirably move to their open condition 60, which presents a variety of potential safety and damage problems while moving the vehicle 16. As such, securing mechanism 30 should be structured and arranged to securely hold side arms 26 in the closed condition 58. A variety of different configurations for the securing mechanism 30 can be utilized with the shade apparatus 10. In the embodiment shown in the figures, securing mechanism 30 is a pair of strap members 74 that are fixedly attached to the housing 18 that are removably attached utilizing a connecting mechanism 76 such as Velcro®, snaps, buckle, button or the like. Alternatively, the connecting mechanism 76 can be the straps 74 themselves that are tied together to secure the side arms 26 to the housing 18. In another alternative configuration, securing mechanism 30 can comprise a strap member 74 that engages, with a connecting mechanism 76, the outer of the two folded side arms 26 (i.e., Velcro® on the strap engages a Velcro® on the outer surface of the outside side arm 26). The securing mechanism 30 can also comprise a wide variety of different connecting mechanisms 76, including hooks, brackets, pin/slot combinations, ties, cords and other such devices that are well known in the art. If desired, a locking device can be utilized with the securing mechanism 30 to allow the user to lock the side arms 26 in their closed condition 58 to prevent unauthorized access thereto.

The components of shade apparatus 10 can be made out of a variety of different materials, which are preferably selected for their ability to generally withstand the intended use of shade apparatus 10, namely on the side of a rack 12 or vehicle 14 and in an outdoor environment. The housing 18, mounting mechanism 20 and side arms 26 are preferably made out of metal or non-metal materials such as fiberglass, certain plastics and/or composites that are able to provide the protective cover, stiffness and degradation resistance required for a reasonably long life of use of the shade apparatus 10. If these components are made out of metal, they may need to be coated or otherwise treated to provide the necessary resistance to corrosion and other environmental damage. The shade apparatus 10 is installed on a rack 12 or vehicle 14 by utilizing mounting mechanism 20. In the embodiment shown in the figures, with brackets 54, a corresponding number of holes are drilled in frame member 50 of rack 12 or in the sidewall 52 of vehicle 14 at the appropriate level above the ground and with the appropriate spacing between the holes to match up with the holes in the brackets 54 so that a bolt or other connector 56 can be utilized to mount housing 18 to the rack 12 or vehicle 14. In other embodiments, screws or like connectors 56 can be driven directly into frame member 50 or sidewall 52, as appropriate, or the brackets 54 (or other components) can be welded thereto without the need for holes in the frame member 50 or sidewall 52.

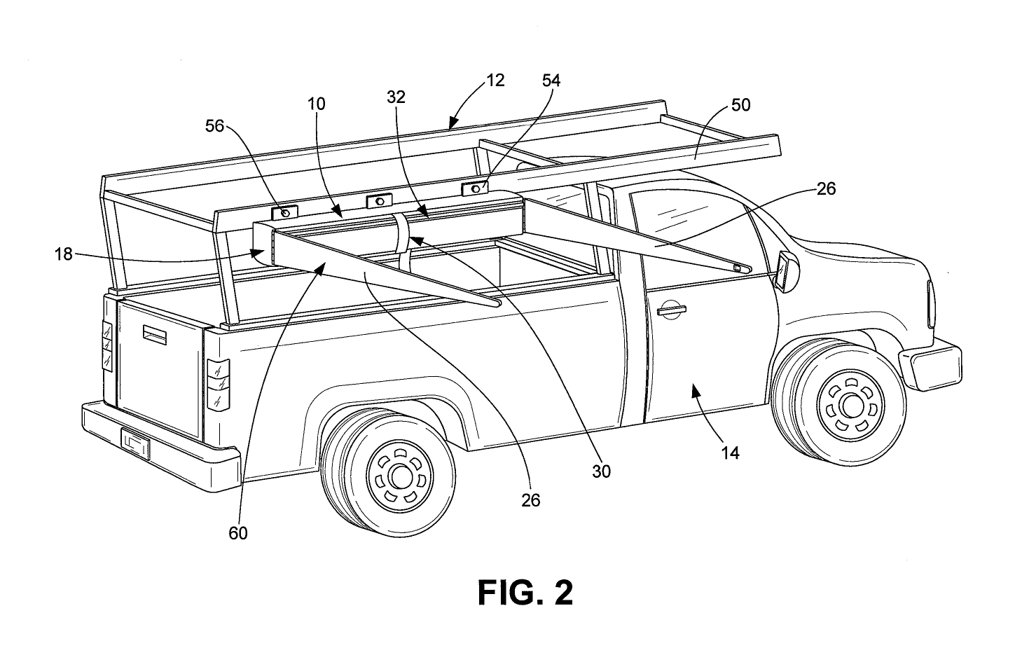

In use, the shade apparatus 10 will be attached to a frame member 50 of a rack 12 or a sidewall 52 of vehicle 14 and, as such, will be driven around with vehicle 14 and parked at a job site or other location where a shaded area 16 may be needed. The shade screen 22 will in its retracted position 34 and the side arms 26 will be in their closed condition 58, as best shown in FIGS. 1 and 5. When shaded area 16 is needed, or anticipated to be needed, the user will disengage the securing mechanism 30 to release the side arms 26 and place the side arms 26 in their open condition 60, as best shown in FIGS. 2-4, 6-7 and 10, by pivoting the side arms 26 away from housing 18 until they extend generally perpendicular to housing 18 with their distal ends 64 outwardly disposed relative to the housing 18. The user then grasps the bar member 48 of the shade screen 22, or a handle or other grasping device at the second end 46 of the screen body 42 (if utilized), and pulls the shade screen out of the housing 18, as shown in FIG. 3, until the body 42 of shade screen 22 is fully extended, with the second end 46 distally disposed relative to the housing 18 and approximately adjacent to the distal ends 64 of side arms 26. The user then engages the locking mechanism 28 to lock the shade screen 22 in its extended position 34, as shown in FIGS. 4, 7 and 10, to produce the shaded area 16 substantially adjacent to vehicle 14, as shown in FIGS. 4 and 10. In the embodiment shown in the figures, the ends 68 of the bar member 48 are placed inside of the engagement openings 70 near the distal ends 64 of the side arms 26 so as to engagedly interconnect the second end 46 of the shade screen 22 with the distal ends 64 of the side arms 22 in a manner that holds the shade screen 22 generally taut between housing 18, side arms 26 and bar member 48. When the shaded area 16 is no longer needed and/or the vehicle 14 needs to be moved, the user takes down shade apparatus 10 by disengaging the locking mechanism 28 (i.e., pulling the ends 68 of bar member 48 out of the engagement openings 70 in side arms 26) and allowing the retracting mechanism 24 to retract the shade screen 22 into the chamber 38 of housing 18 through the slit 40. Once the second end 46 of the shade screen 22 or the bar member 48 thereof is at the housing 18, the user will fold each of the side arms 26 inward to their closed condition 58 so the side arms 26 are at least substantially against a side wall 36 of housing 18, typically covering the second end 46 and bar member 48 of shade screen 22 and the slit 40 in housing 18, as shown in FIGS. 1 and 5. The user then engages the securing mechanism 30, such as connecting the two strap members 74 together with the Velcro® or other connecting mechanism 76, to secure the side arms 26 to the housing 18. Once secured, the vehicle 14 can be safely moved.

As will be readily appreciated by those skilled in the art, a number of variations to the configurations described above and shown in the figures can be made to the shade apparatus 10. For instance, each of the side arms 26 can be telescopically configured such that the user can extend them, and shade screen 22, to the desired length to produce the desired/needed amount of shaded area 16. Likewise, each of the two side arms 26 can be provided with one or more additional engagement openings 70 to allow the user to lock the shade screen 22 at different places along the lengths of side arms 26 to provide varying amounts of shaded area 16. As set forth above, the material or materials for the body 42 of shade screen 22 should be selected to provide the desired level of shading for the shaded area 16. In the embodiments of FIGS. 3-4 and 7-8, the body 42 of shade screen 22 is solid, providing complete shading but no air flow, whereas the body 42 of shade screen 22 shown in FIG. 10 is of the type that has a plurality of small openings that, while still providing shading for shaded area 16, allows some amount of air to flow therethrough. A wide variety of other modifications and alterations can also be made to shade apparatus 10 and fall within the scope of the present invention.

While there are shown and described herein one or more specific embodiments of the present invention, it will be readily apparent to those skilled in the art that the invention is not so limited, but is susceptible to various changes in quantities and materials without departing from the spirit and scope of the invention. The foregoing descriptions of specific embodiments of the present invention have been presented for purposes of illustration and description and are not intended to be exhaustive or to limit the scope of the invention to the precise forms disclosed. The above embodiments were set forth above for the purposes of best illustrating and explaining the principles of the present invention and one or more practical uses thereof so as to enable persons skilled in the art to best understand and utilize the present invention. Persons skilled in the art will readily understand and appreciate that they will be able to utilize the teachings of this disclosure to modify the present invention as may be necessary to suit their specific needs and/or requirements without departing from the spirit or scope of the claims of the present invention.

What is claimed is:

1. A shade apparatus, comprising:
a housing enclosing a chamber therein;
a shade screen having a body made out of one or more materials selected so as to provide a shaded area when acted upon by light, said body of said shade screen having a first end and a second end;
retracting means disposed in said chamber of said housing and operatively attached to said first end of said shade screen, said retracting means configured to allow said shade screen to move between a retracted position having said shade screen substantially in said housing with said second end of said body of said shade screen at said housing and an extended position having said second end of said body extending outwardly from said housing so as to produce said shaded area;
one or more side arms pivotally attached to said housing, each of said one or more side arms configured to pivot between a closed condition with said side arms substantially adjacent said housing and an open position with said side arms extending outwardly from said housing generally toward said second end of said shade screen when said shade screen is in said extended position; and
locking means associated with and interconnecting said shade screen and said one or more side arms for locking said shade screen in said extended position.

2. The shade apparatus of claim 1 further comprising mounting means attached to said housing for mounting said housing to a rack or to a vehicle.

3. The shade apparatus of claim 2, wherein said shade apparatus is utilized with a rack on a vehicle and said mounting means is configured to attach said housing to a frame member of said rack so as to provide said shaded area substantially adjacent said vehicle.

4. The shade apparatus of claim 2, wherein said shade apparatus is utilized with a vehicle and said mounting means is configured to attach said housing to a side of said vehicle so as to provide said shaded area substantially adjacent said vehicle.

5. The shade apparatus of claim 2, wherein said mounting means comprises one or more brackets attached to said housing, said mounting means structured and arranged to be mounted to said rack or to said vehicle.

6. The shade apparatus of claim 1 further comprising securing means associated with said housing for securing said side arms in said closed position.

7. The shade apparatus of claim 6, wherein said securing means comprises one or more strap members attached to said housing and a connecting mechanism associated with at least one of said strap members.

8. The shade apparatus of claim 1, wherein said locking means comprises an elongated bar member laterally disposed at the second of said shade screen and one or more engagement openings in each of said side arms.

9. The shade apparatus of claim 8, wherein said bar member has ends that extend beyond said body of said shade screen, said ends of said bar member cooperatively sized and configured with said engagement openings to be received in said engagement openings to lock said shade screen in said extended position.

10. A shade apparatus, comprising:
a housing enclosing a chamber therein;
mounting means attached to said housing for mounting said housing to a rack or to a vehicle;
a shade screen having a body made out of one or more materials selected so as to provide a shaded area when acted upon by light, said body of said shade screen having a first end and a second end;
retracting means disposed in said chamber of said housing and operatively attached to said first end of said shade screen, said retracting means configured to allow said shade screen to move between a retracted position having said shade screen substantially in said housing with said second end of said body of said shade screen at said housing and an extended position having said second end of said body extending outwardly from said housing so as to produce said shaded area;
two side arms pivotally attached to said housing, each of said side arms configured to pivot between a closed condition with each of said side arms substantially adjacent said housing and an open position with each of said side arms extending outwardly from said housing generally toward said second end of said shade screen when said shade screen is in said extended position; and
locking means associated with and interconnecting said second end of said shade screen and each of said side arms for locking said shade screen in said extended position.

11. The shade apparatus of claim 10, wherein said shade apparatus is utilized with a rack on a vehicle and said mounting means is configured to attach said housing to a frame member of said rack so as to provide said shaded area substantially adjacent said vehicle.

12. The shade apparatus of claim 10, wherein said shade apparatus is utilized with a vehicle and said mounting means is configured to attach said housing to a side of said vehicle so as to provide said shaded area substantially adjacent said vehicle.

13. The shade apparatus of claim 10, wherein said mounting means comprises one or more brackets attached to said housing, said mounting means structured and arranged to be mounted to said rack or to said vehicle.

14. The shade apparatus of claim 10, wherein said locking means comprises an elongated bar member laterally disposed at the second of said shade screen and one or more engagement openings in each of said side arms.

15. The shade apparatus of claim 14, wherein said bar member has ends that extend beyond said body of said shade screen, said ends of said bar member cooperatively sized and configured with said engagement openings to be received in said engagement openings to lock said shade screen in said extended position.

16. The shade apparatus of claim 10 further comprising securing means associated with said housing for securing said side arms in said closed position.

17. A shade apparatus, comprising:
a housing enclosing a chamber therein;
one or more brackets attached to said housing, said brackets structured and arranged so as to mount said housing to a rack or to a vehicle;
a shade screen having a body made out of one or more materials selected so as to provide a shaded area when acted upon by light, said body of said shade screen having a first end and a second end;
retracting means disposed in said chamber of said housing and operatively attached to said first end of said shade screen, said retracting means configured to allow said shade screen to move between a retracted position having said shade screen substantially in said housing with said second end of said body of said shade screen at said housing and an extended position having said second end of said body extending outwardly from said housing so as to produce said shaded area;
two side arms pivotally attached to said housing, each of said side arms configured to pivot between a closed condition with each of said side arms substantially adjacent said housing and an open position with each of said side arms extending outwardly from said housing generally toward said second end of said shade screen when said shade screen is in said extended position;
locking means associated with and interconnecting said shade screen and said side arms for locking said shade screen in said extended position, said locking means comprising an elongated bar member laterally disposed at the second of said shade screen and one or more engagement openings in each of said side arms, said bar member having ends that extend past beyond said body of said shade screen, said ends of said bar member cooperatively sized and configured with said engagement openings to be received in said engagement openings to lock said shade screen in said extended position; and
securing means associated with said housing and at least one of said one or more side arms for securing said side arms in said closed position.

18. The shade apparatus of claim 17, wherein said shade apparatus is utilized with a rack on a vehicle and said one or more brackets are configured to attach said housing to a frame member of said rack so as to provide said shaded area substantially adjacent said vehicle.

19. The shade apparatus of claim 17, wherein said shade apparatus is utilized with a vehicle and said brackets are configured to attach said housing to a side of said vehicle so as to provide said shaded area substantially adjacent said vehicle.
